(19) United States
(12) Patent Application Publication
(10) Pub. No.: US 2005/0006850 A1
(43) Pub. Date: Jan. 13, 2005

(54) Shaft of a shredding device and a shredding device

(76) Inventors: Gerold Barth, Wilhering (AT); Manfred Dobersberger, Pasching (AT); Gunter Kroiss, Pasching (AT); Thomas Pichler, Haslach (AT); Walter Schmedler, Timmelkam (AT)

Correspondence Address: YOUNG & THOMPSON, 745 SOUTH 23RD STREET, 2ND FLOOR, ARLINGTON, VA, 22202, US

(21) Appl. No.: 10/832,340

(22) Filed: Apr. 27, 2004

(30) Foreign Application Priority Data
May 5, 2003 (AT) A 674/2003

(51) Int. Cl. F16J 9/00

(52) U.S. Cl. 277/300

(57) ABSTRACT

A shaft of a device for shredding of especially film-like thermoplastics having at least one spiral (8) as the shredding tool. The spiral (8) is subdivided by at least one opening (10) into spiral segments (9). The opening (10) is bordered by surfaces (11) which are located on the ends (12, 13) of the individual spiral segments (9). The surfaces (11) are located at an angle of roughly 90° to the axis (14) of rotation of the shaft (3).

The invention relates to the shaft of a device for shredding of especially film-like thermoplastics, with at least one spiral as the shredding tool on the shaft, the spiral being subdivided by at least one opening into the spiral segments.

Such a shaft is disclosed in AT 6 145 U. The shaft which is described there has spiral or worm segments between Which there are openings. These openings are bordered by surfaces which lie in axial planes. Several disadvantages are associated with them. One of these disadvantages is that in the area of these end or front surfaces plastic particles or pieces of film can stick which can adversely affect not only the cutting action between the comb and the spiral segments, but also the continuous conveyance of the plastic particles or pieces of film. Another disadvantage is that this shape of the openings and the end or front surfaces causes an unfavorable length ratio between the openings and the spiral segments, since for a certain length of an opening which is measured in the axial direction unusually dramatic shortening of the spiral segment length occurs. The resulting relatively short spiral segment length in turn has a disadvantageous effect for continuous and reliable conveyance of the plastic.

Therefore the object of the invention is to avoid or mitigate these disadvantages.

This object is achieved with a shaft with the features of claim 1.

In the invention the surfaces which border the openings on the ends of the spiral segments are no longer located in the axial plane, but at an angle of greater than 0° to the axis of rotation of the shaft. This “tilting” of the surfaces with reference to the axis of rotation, compared to AT 6 145 U, results in that the effective spiral segment length is increased while the length of the openings which is measured in the axial direction can remain the same. The “tilting” of the surfaces also reduces the accumulation of plastic particles on these surfaces, since they can now slide more easily off these surfaces.

In one preferred embodiment of the invention the surfaces are located at an angle of greater than 45°, preferably greater than 80° to the axis of rotation of the shaft. In this arrangement of the surfaces the advantages of the invention over the prior art become more noticeable.

In one especially preferred embodiment of the invention the surfaces are located at an angle of roughly 90° to the axis of rotation of the shaft. This embodiment offers the advantage that the openings can be produced very easily by milling the openings with the tool stationary by simple rotation of the shaft. This yields surfaces which are located roughly parallel to one another as claimed in the invention.

In one alternative embodiment it can also be provided that the surfaces are tilted to one another at an angle of less than 20°, preferably less than 10° to one another. This arrangement makes it possible to take into account particulars for example with respect to the plastics which are to be shredded, such as films or other, for example, granulate or material which has been shredded beforehand, in which tilting of the surfaces can prove advantageous.

It is especially preferable when the surfaces have a clearance which proceeding from the ends of the spiral segments are located at an angle of less than 10°, preferably less than 5° to the radial plane. This clearance can effectively prevent deposits on the surface which for example can adversely affect the shredding function or can degrade efficiency.

In preferred embodiments of the invention it can be provided that the length ratio of the spiral segments to the opening measured in the axial direction is between 2:1 and 5.5:1, preferably between 3.0:1 and 4.5:1, especially preferably between 3.5:1 and 4.0:1. These length ratios ensure that at an adequate width of the teeth of the comb for satisfactory shredding of the plastic parts and for reliable prevention of deposits or “blocking” in the threads between the spiral segments there are sufficiently long spiral segments which are advantageous for reliable conveyance of the plastic.

Even if it is possible for individual spiral segments to be longer or shorter than others (for example, there can be spiral segments which are longer on the output side than the input side, i.e. in the area of the feed of the plastic to the shaft), in one preferred embodiment it can also be provided that all spiral segments have essentially the same length, by which a uniform conveyance and shredding action over the entire length of the shaft is ensured.

In other preferred embodiments of the invention it can be provided that the shaft is cylindrical and/or that an imaginary surface which jackets the spiral segments is cylindrical. A cylindrical execution of the shaft and the spiral segments is simpler to produce than a conical shape. But any combination of a cylindrical or conical shaft with a cylindrical or conical surface which jackets the spiral segments is also possible.

Furthermore, in one preferred embodiment of the invention flanks of the spiral segments which are essentially parallel to one another can be easily produced.

The invention furthermore relates to a device for shredding of especially film-like thermoplastics, with a housing in which a shaft with spiral segments is rotationally held, with a feed opening in the housing, and with at least one comb with teeth which project between the spiral segments, which is characterized as claimed in the invention in that the shaft is executed as claimed in one of claims 1 to 11.

In one preferred embodiment of the invention it can be provided that there are two combs and that the first comb is located at an angle between 110° and 160°, preferably between 125° and 145° C. measured out from the center of the feed opening, and the second comb is located at an angle between 250° and 290°, preferably between 260° and 280° C.

It has been found that with a corresponding arrangement of the two combs there is satisfactory shredding of the plastic with moreover reliable and continuous transport of the plastic in the conveyance direction.

But since it can happen that there is still not enough conveyor pressure on the plastic for the first comb since the first comb lies relatively near the feed opening, within the framework of the invention the first comb can also be omitted and only a second comb can be used which is a relatively short distance in front of the feed opening viewed in the direction of rotation of the shaft, in a likewise reliable functionality the costs being lower.

The shaft and device as claimed in the invention can be operated in isolation, i.e. without following components which further process the plastic. But it is preferable, as is disclosed by AT 6 145 U, if in the axial direction an extruder housing adjoins the housing and an extruder shaft adjoins the shaft.

Other features and advantages of the invention follow from the description of one preferred embodiment of the invention below with reference to the drawings.

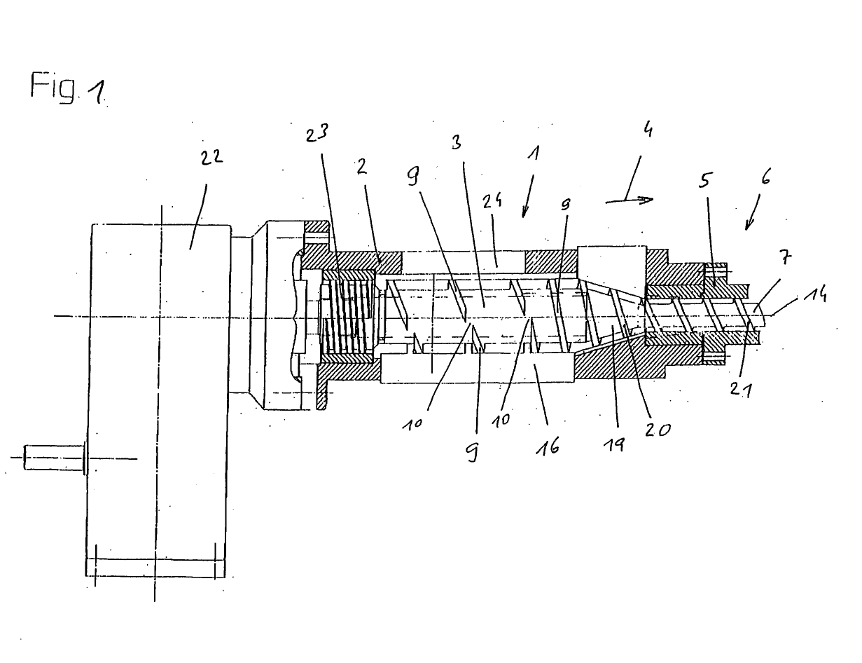

FIG. 1 shows a section through a device for shredding of plastics with a shaft as claimed in the invention and an added extruder;

FIG. 2 shows a shaft as claimed in the invention,

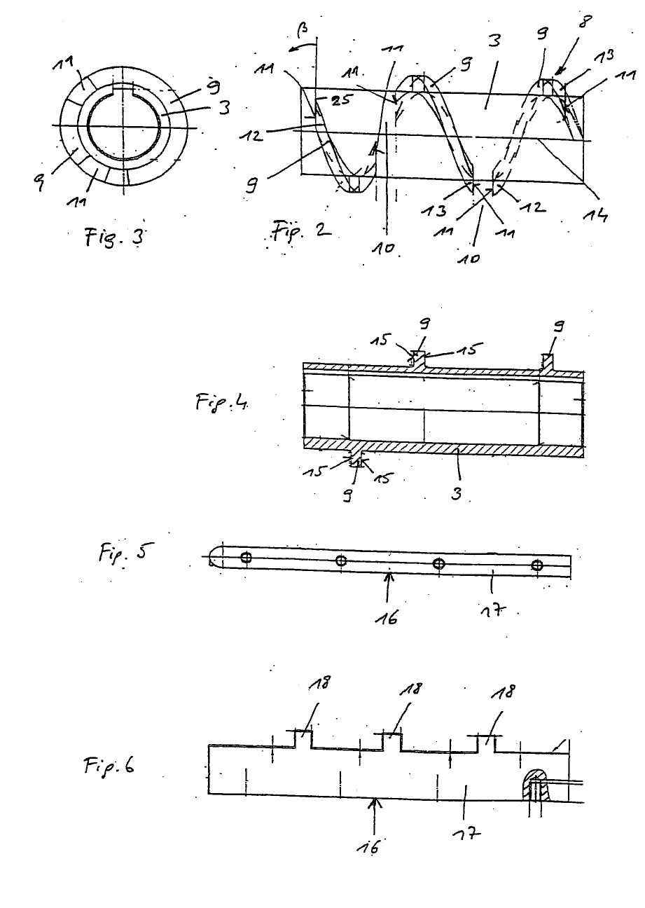

FIG. 3 a view of the shaft from FIG. 2 from the right,

FIG. 4 a section through the shaft from FIG. 2 and

FIGS. 5 and 6 show a comb in a horizontal projection and a vertical section.

FIG. 1 shows an arrangement consisting of a device for shredding and conveying especially film-like thermoplastics and an extruder in a lengthwise section. The device 1 for conveying and shredding has a housing 2 in which the shaft 3 is rotationally held. The plastic which is to be shredded is supplied by a feed opening 24 through the housing 2 to the shaft 3. Viewed in the conveyor direction 4 the housing 2 is adjoined by the extruder housing 5 of an extruder 6 in which the extruder shaft 7 turns.

The shaft 3 as claimed in the invention has a spiral 8 which in the embodiment shown in FIG. 2 consists of three spiral segments 9 which are separated from one another by openings 10.

The openings 10 are bordered by surfaces 11 which are located on the ends 12 and 13 of the spiral segments 9, and in the illustrated embodiment form the end or front surfaces.

As FIG. 2 shows, the surfaces 11 are aligned parallel to one another and lie in radial planes, by which they can be produced very easily by positioning a milling head in the area of the openings 10 and producing the openings 10 by simply turning the shaft 3.

It goes without saying that the representation of the shaft in FIGS. 2 to 4 is only an example in order to show the arrangement of the spiral segments 9 and openings 10 and that both the number and the shape of the spiral segments 9 and the openings 10 can be varied within the framework of the claims, especially with regard to their number and shape or dimensions and length. In particular FIGS. 2 to 4 show, unlike as in FIG. 1, those areas in which the shaft 3 adjoins the extruder shaft 7. Likewise it is fundamentally possible to use more than one spiral 8 with spiral segments 9, for example two spirals 8 and to provide the spiral with a changing lead.

While FIGS. 2 to 4 show an embodiment in which the surfaces 11 are located at an angle of 90° to the axis 14 of rotation of the shaft, it can also be advantageous to arrange the surfaces at an angle β to the radial plane in order to obtain a clearance of the surface 11. In this way the tip 25 which is decisive for shredding the plastic also becomes somewhat more pointed, by which the shredding action is further improved. The surface 11 which is opposite in the opening 10 can likewise be tilted, either in the same direction β or in the opposite direction and with the same or a different dimension.

The surfaces 11 can also be tilted such that the openings 10 widen to the outside in the radial direction.

As is especially apparent in FIG. 4, the flanks 15 of the spiral segments 9 are aligned parallel and radially, but a different cross section of the spiral segments also being conceivable, as is described for example in AT 6145 U.

A comb 16 which can be used in the device as claimed in the invention is shown in FIGS. 5 and 6. The comb 16 has a base body 17 on which there are teeth 18 with a basic shape which corresponds roughly to the shape of the opening 10, on the condition that the teeth 18 are somewhat smaller or narrower so that they can fit with play in the openings 10 between the surfaces 11. In FIG. 1 the comb 16 is not shown in its actual operating position, but for reasons of presentation in a position which has been turned down into the plane of the figure.

In the transition area between the shaft 3 and the extruder shaft 7 there is a transition cone 19 with a correspondingly shaped worm 20 which seamlessly adjoins one spiral segment 9 on the one hand and the worm 21 of the extruder shaft 7 on the other.

The shaft 3 can be made integrally with the transition cone 19 and the extruder shaft 7. But it is also possible for the shaft 3, as is apparent in FIG. 4, to be a hollow shaft through which an extension of the extruder shaft 7 extends as far as gearing 22 which is located on the other end. For a torsionally strong connection of the shredding shaft 3 to the continuous shaft, for example, there can be a feather key connection. On the end opposite the extruder shaft 7 the shaft 3 is adjoined by a bearing 23 in order to prevent overly great deflections of the shaft 10.

1. Shaft of a device for shredding of especially film-like thermoplastics, with at least one spiral (8) as the shredding tool on the shaft (3), the spiral (8) being subdivided by at least one opening (10) into spiral segments (9), characterized in that the opening (10) is bordered by surfaces (11) which are located on the ends (12, 13) of the individual spiral segments (9) and that the surfaces (11) are located at an angle of greater than 0° to the axis (14) of rotation of the shaft (3).

2. Shaft as claimed in claim 1, wherein the surfaces (11) are located at an angle of greater than 45°, preferably greater than 80° to the axis (14) of rotation of the shaft (3).

3. Shaft as claimed in claim 1, wherein the surfaces (11) are located at an angle of roughly 90° to the axis (14) of rotation of the shaft (3).

4. Shaft as claimed in claim 1, wherein the surfaces (11) are tilted to one another at an angle of less than 20°, preferably less than 10° to one another.

5. Shaft as claimed in claim 1, wherein the surfaces (11) have a clearance which proceeding from the ends (12, 13, 25) of the spiral segments (9) are located at an angle (β) of less than 10°, preferably less than 5° to the radial plane.

6. Shaft as claimed in claim 1, wherein the surfaces (11) are arranged roughly parallel to one another.

7. Shaft as claimed in claim 1, wherein the length ratio of the spiral segment (9) to the opening (10) measured in the axial direction is between 2:1 and 5.5:1, preferably between 3.0:1 and 4.5:1, especially preferably between 3.5:1 and 4.0:1.

8. Shaft as claimed in claim 1, wherein all spiral segments (9) have essentially the same length.

9. Shaft as claimed in claim 1, wherein it is cylindrical.

10. Shaft as claimed in claim 1, wherein an imaginary surface which jackets the spiral segments (9) is cylindrical.

11. Shaft as claimed in claim 1, wherein the flanks (15) of the spiral segments (9) are essentially parallel to one another.

12. Device for shredding of especially film-like thermoplastics, with a housing (2) in which a shaft (3) with spiral segments (9) is rotationally held, with a feed opening (24) in the housing (2) and with at least one comb (16) with teeth (18) which project between the spiral segments (9), wherein the shaft (3) is executed as claimed in claim 1.

13. Device as claimed in claim 12, wherein there are two combs (16) and wherein the first comb (16) is located at an angle between 110° and 160°, preferably between 125° and 145° C. measured out from the center of the feed opening (24), and the second comb (16) is located at an angle between 250° and 290°, preferably between 260° and 280° C.

14. Device as claimed in claim 12, wherein, as is known, in the axial direction an extruder housing (5) adjoins the housing (2) and an extruder shaft (7) adjoins the shaft (3).
